(19) United States
(12) Patent Application Publication
(10) Pub. No.: US 2012/0290616 A1
(43) Pub. Date: Nov. 15, 2012

(54) INTERWORKING SYSTEM AMONG A PLURALITY OF DISTRIBUTED VIRTUAL WORLDS USING A UNIVERSALLY UNIQUE DISTRIBUTED OBJECT ID AND METHOD FOR SAME

(76) Inventor: Sang Zee Lee, Daejeon (KR)

(21) Appl. No.: 13/574,382

(22) PCT Filed: Jan. 7, 2011
(86) PCT No.: PCT/KR2011/000115

§ 371 Date: Jul. 20, 2012

(30) Foreign Application Priority Data
Jan. 22, 2010 (KR) 10-2010-0006180

(51) Int. Cl. G06F 17/30

(52) U.S. Cl. 707/770; 707/803; 707/E17.014; 707/E17.032

(57) ABSTRACT

An interworking system among a number of distributed virtual worlds and a method for the same. The virtual world object includes an object having a URL address and a universal content ID (UCI), and an object managed via a DB without the above-mentioned URL address or UCI. As the use of a distributed object ID that uniquely and universally identifies various objects with the same format enables interworking and sharing among a number of virtual worlds, the open virtual world can be implemented easily and efficiently. That is, various pieces of object information can be shared among different kinds of distributed virtual worlds in the open virtual world. The open virtual world also provides an application service via interworking, such as the free movement of an avatar from one world to another virtual world, and the exchange of information between avatars that belong to different virtual worlds.

### CROSS REFERENCE TO RELATED APPLICATIONS AND CLAIM OF PRIORITY

This patent application is a National Phase application under 35 U.S.C. §371 of International Application No. PCT/KR2011/000115, filed on Jan. 7, 2011, which claims priority to Korean Patent Application number 10-2010-0006180 filed Jan. 22, 2010, entire contents of which are incorporated herein by reference.

### BACKGROUND

1. Field of the Invention

The present invention relates to an interworking system among a plurality of distributed virtual worlds and a method for the same, and more particularly, to an interworking system and a method for the same which register any of all objects which exist in virtual worlds such as avatars existing in a plurality of virtual worlds, spatial objects constituting two-dimensional (2D) or three-dimensional (3D) virtual spaces, and location information of avatars and spatial objects in virtual spaces, and multimedia content by using a unique ‘distributed object ID’ in an ‘object # object information server identifier’ format, store the ‘distributed object ID’ along with object information in an object information server, and enable all the objects existing in the virtual worlds such as the avatars, the spatial objects, and the multimedia content to interwork with one another among a plurality of different kinds of distributed virtual worlds by using the ‘distributed object ID’ registered and stored in the object information server in the plurality of different kinds of distributed virtual worlds.

2. Description of the Related Art

A virtual world is a computer-based simulated environment where spatial objects created with two-dimensional (2D) or three-dimensional (3D) graphics and various pieces of multimedia content exist and the objects interact just as in a real world. A specific environment is created by using a computer and human-computer interaction occurs such that a user interacts with the specific environment as if he/she is in the specific environment. In general, a user moves in a virtual world by using an avatar and communicates with other avatars or objects. An avatar often takes a texture, 2D, or 3D form, and communications between users is made by using text, graphic icons, visual gesture, sound, or even touch or sense.

A closed virtual world which has been initially developed lacks compatibility and does not allow object information such as an avatar, a spatial object, or multimedia content to be shared between different virtual words, thereby providing an independent virtual world service. For example, ‘Second Life’ (U.S.) which is a widely known virtual world provides an independent virtual world service.

Recently, there has been a demand for an open virtual world with compatibility between different kinds of distributed virtual worlds in which a spatial object and multimedia content created in one virtual world may be shared among different virtual worlds and an avatar may freely move from one virtual world to another virtual world. Accordingly, there has been developed an open virtual world in which ‘an object ID’ for universally and uniquely identifying each object and making object information shared between different virtual worlds is assigned and the different virtual worlds share the object information by using the ‘object ID’.

When the ‘object ID’ is a universally unique resource locator (URL) address, the open virtual world provides an open virtual world service by which a URL address is assigned to each object and corresponding object information is shared by using the URL address in a Web-based virtual world. For example, ‘MetaPlace’ (U.S.) and ‘SmallWorlds’(New Zealand) provide an open virtual world service.

For another example, a universal content identifier (UCI) which is a digital content identification system using a uniform resource name (URN) (KOREA) may be used. The UCI has similar characteristics to the URN, but is different from the URN in that content itself is uniquely identified irrespective of a location of the content. The use of the UCI is disclosed in, for example, G300-b1228646X.v26n5p193.

### SUMMARY

An initial virtual world is a so-called closed virtual world in which an interworking service such as sharing of object information between different virtual worlds or the free movement of an avatar belonging to a specific virtual world from one virtual world to another virtual world is impossible or very difficult, and thus an independent virtual world service is provided. A representative example of a closed virtual world is Second Life (U.S.). Since various objects such as an avatar, a spatial object, multimedia content, and location information in a virtual world which constitute Second Life are developed in different data formats, compatibility between virtual worlds is lacked, and since a unique object ID technology for ensuring compatibility is not used, it is almost impossible to share data of the various objects among a plurality of virtual worlds.

In order to solve the lack of compatibility between virtual worlds in the closed virtual world, there has been developed a so-called open virtual world in which a so-called uniform resource locator (URL) address for universally and uniquely identifying each object is assigned to the object and the object is shared based on the Web among a plurality of distributed virtual worlds by using the URL address.

Examples of the open virtual world include MetaPlace (U.S.) and SmallWorlds (New Zealand). An open virtual world provides a service by which a URL address is assigned to an object constituting a virtual world and the object is shared based on the Web among a plurality of virtual worlds by using the URL address. However, the open virtual world has some limitations in sharing object data among a plurality of different kinds of distributed virtual worlds.

First, a method of assigning a URL to an object has a problem in that when a location where object information is stored is changed, for example, when a location of data about object information in a server constituting a virtual world is changed or the server is changed, a URL indicating the object information is also changed. If information about the changed URL is not notified to all virtual world service providers or users, the users or specific users may not access the object, thereby failing to access the object. In particular, since it is difficult for a plurality of general users to know that a URL has been changed due to personal reasons of an object information provider, an incomplete virtual world service may be provided for a long time.

Second, since a URL address contains English alphabetic characters and thus it is difficult for a user to intuitively read or memorize the URL address, user convenience is reduced and it is difficult to provide a service in native languages in countries which do not use English.

Third, when an object is managed via a DB instead of the Web, a service of sharing the object between virtual worlds using a URL is limited.

Last, when an ‘object ID’ for identifying an avatar is a URL address, a service of exchanging information between avatars using the URL address is limited. This is because since a URL which is an address indicating a location of data existing on the Internet is mainly used to search for and share information related to the corresponding avatar by using a web browser, it is not appropriate to use the URL as an address for exchanging a message between avatars.

Also, since a UCI classifies content according to types, designates a registration management agency, and limits an object information server in which object information is registered and stored, expandability and flexibility required for an open virtual world are lacked. Since it is difficult to know an address of an object information server in which corresponding content is registered and stored by using only a UCI, usability is limited.

The present invention provides an interworking system and a method for the same in which various virtual world objects include an object having a URL address, an object having a UCI, and an object managed via a DB without a URL address or a UCI, and are shared among a plurality of virtual worlds by using a distributed object ID for universally and uniquely identifying various objects with the same format.

Unlike a traditional closed virtual world, an open virtual world is characterized in that various pieces of object information may be shared among a plurality of different kinds of distributed virtual worlds, and an application service through interworking such as the free movement of an avatar belonging to a specific virtual world from one virtual world to another virtual world and the exchange of information between avatars that belong to different virtual words may be provided.

In order to ensure compatibility between open virtual worlds, when various objects constituting a virtual world need to be registered and stored in a plurality of distributed heterogeneous object information servers, a system and a service method for universally and uniquely identifying in a systematic and integrated manner the various objects registered and stored in the heterogeneous object information servers are required.

The present invention provides an interworking system among a plurality of distributed virtual worlds using a universally unique ‘distributed object ID’ and a method for the same. Here, a ‘distributed object ID’ for universally and uniquely identifying an object constituting a virtual world is a character string in a ‘object identifier # object information server domain name’ format, an ‘object information server domain name’ constituting the ‘distributed object ID’ indicates an Internet address for universally and uniquely identifying an object information server in which object information and the ‘distributed object ID’ for identifying the object information are registered and stored, an ‘object identifier’ constituting the ‘distributed object ID’ indicates an object ID for uniquely identifying specific object information registered and stored in the same object information server, # constituting the ‘distributed object ID’ indicates a so-called a ‘delimiter’ which separates the ‘object information server domain name’ from the ‘object identifier’ and distinguishes the ‘distributed object ID’ from a similar e-mail address. The ‘delimiter’ further includes !, $, %, ̂, & and * in addition to #, and one of the !, $, %, ̂, & and * is selected and used as a ‘delimiter’ of the ‘distributed object ID’. Also, the ‘delimiter’ is not limited thereto and other symbols may be used in consideration of the scope and technology of the present invention.

According to an aspect of the present invention, there is provided an interworking system among a plurality of distributed virtual worlds using a universally unique a ‘distributed object ID’, a method for the same, and a method of providing an open search service of searching for object information including a specific character string from an interworking database among the plurality of distributed virtual worlds, wherein the interworking system includes:

an object information database that includes a ‘distributed object ID’ and heterogeneous object information such as an avatar, a spatial object, multimedia content, or location information in a virtual world which is uniquely identified by using the ‘distributed object ID’, wherein the ‘distributed object ID’ includes an ‘object identifier’ and an ‘object information server domain name’ and is formatted with a ‘delimiter’ between the ‘object identifier’ and the ‘object information server domain name’, wherein the ‘object information server domain name’ is a unique character string indicating a domain name of an object information server in which object information is registered and stored and the ‘object identifier’ is a unique character string in the same object information server to uniquely identify the object information registered and stored in the object information server;

an object information server that registers, stores, updates, and erases the ‘distributed object ID’ and the object information in the object information database, searches for information stored in the object information database by using the ‘distributed object ID’ in response to a user's request, and provides a search result;

an object information server domain name server that registers, stores, and manages an IP address corresponding to the object information server, and searches for and provides the IP address in response to the user's request to connect to the object information server;

a virtual world authoring tool that has

a function of accessing at least one or more of objects registered and stored in a plurality of distributed object information servers and editing, erasing, and storing each object by using a ‘distributed object ID’, and

a function of providing a method of combining a plurality of objects having ‘distributed object IDs’ to obtain a complex object and newly creating or assigning a ‘distributed object ID’ to the complex object, or

providing a unit for newly creating an object and newly assigning a ‘distributed object ID’ to the created object, and

constructing a virtual world using a plurality of distributed object IDs such that an object information server in which a corresponding object is registered and stored is connected and corresponding object information stored in an object information database of the connected object information server is shared;

a virtual world server that is connected through the object information server, the object information server domain name server, and a wired/wireless communication network, and provides

a virtual world construction service by which a virtual world is constructed by using an object such as an avatar, a spatial object, or a multimedia content by using the ‘distributed object ID’ registered and stored in the object information database of the object information server,

a virtual world location-based service by which location information in the virtual world associated with the ‘distributed object ID’ is registered, searched for, and moved,

a search and application service of multimedia content associated with the ‘distributed object ID’, and

an interworking service among a plurality of virtual worlds using the ‘distributed object ID’ including the exchange of information between a user and an avatar or between an avatar and an avatar associated with the ‘distributed object ID’; and

a user terminal that is connected through the virtual world server, the object information server, the object information server domain name server, and the wired/wireless communication network, connects to the virtual world in response to the user's request, and provides a virtual world service associated with the ‘distributed object ID’,

wherein an interworking service among a plurality of virtual worlds is provided by associating a plurality of object information servers, a ‘distributed object ID’ for universally and uniquely identifying object information registered and stored in the plurality of object information servers, and the object information,

### BRIEF DESCRIPTION OF THE DRAWINGS

FIG. 1 is a block diagram illustrating an open virtual world;

FIG. 2 is a conceptual diagram for explaining an open virtual world; and

FIG. 3 is a flowchart for explaining an open virtual world service.

### DETAILED DESCRIPTION

The present invention will now be described more fully with reference to the accompanying drawings, in which exemplary embodiments of the invention are shown.

### Embodiment 1

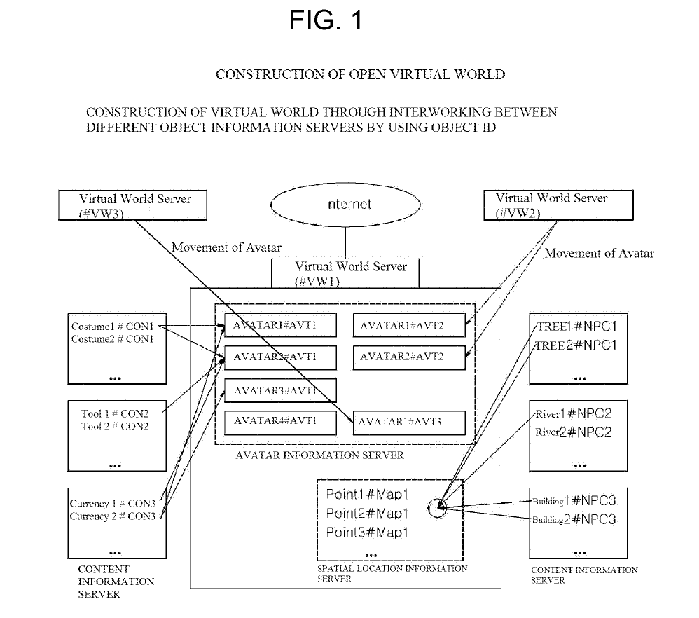

### Referring to FIG. 1,

A distributed object ID is created in a ┌┌ object identifier # object information server domain name ┌┌ format. For example, when an object identifier for a specific avatar object is an ‘avatar 1’ and an object information server domain name is ‘AVT 1’, a distributed object ID is created as ‘avatar 1 # AVT1’.

An avatar object information database in which avatar object information is registered and stored has avatar 1 # AVT1 as an object ID, and has attribute information such as a costume, a tool, or a currency which the avatar object owns and additionally has attribute information such as a facial expression indicating a state of the avatar object. In this case, when an object which an avatar owns has its distributed object ID, ownership information may be expressed by using the distributed object ID.

### Example

distributed object ID: avatar 1 # AVT1

attribute information1: costume 1 # CON1

attribute information2: tool 1 # CON2

attribute information3: currency 1 # CON3

attribute information4: facial expression 7

3) An object information server is a server in which information about objects constituting a virtual world and a distributed object ID corresponding to the information are registered. Although information of all objects may be collected and stored in one object information server, considering that there are various types of objects and a plurality of object suppliers, objects may be classified according to types and suppliers and then stored and managed in one or more servers.

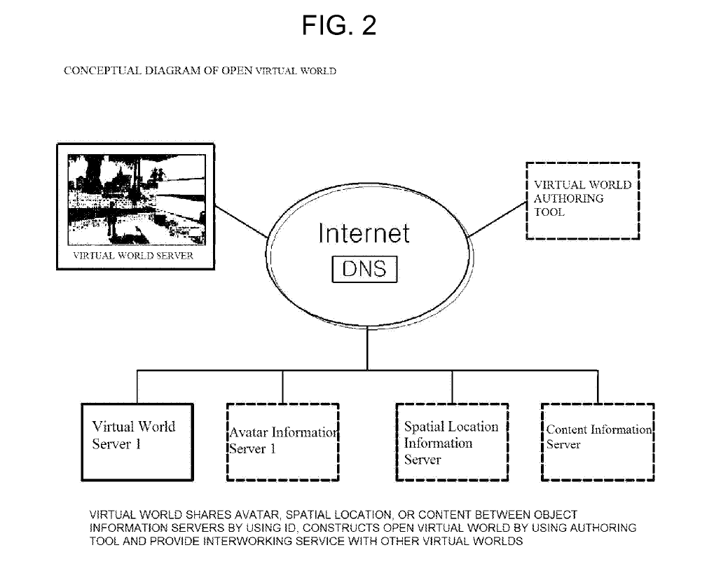

As shown in FIG. 2, an object information server may be classified into an avatar information server, a spatial location information server, and a multimedia content information server.

4) An object information server domain name which is a domain name indicating an Internet address of an object information server is written after # of a distributed object ID as VW1, AVT1, CON1, or MAP1.

5) An object information server domain name server which is a server constructed to refer to an Internet protocol (IP) address corresponding to an object information server domain name may include a domain name server (DNS) which is a principle server of the Internet or a separate server. In general, when an Internet address is IPv4, the object information server domain name server is expressed as 192.168.1.1, and may include IPv6 instead of IPv4.

### Embodiment 2

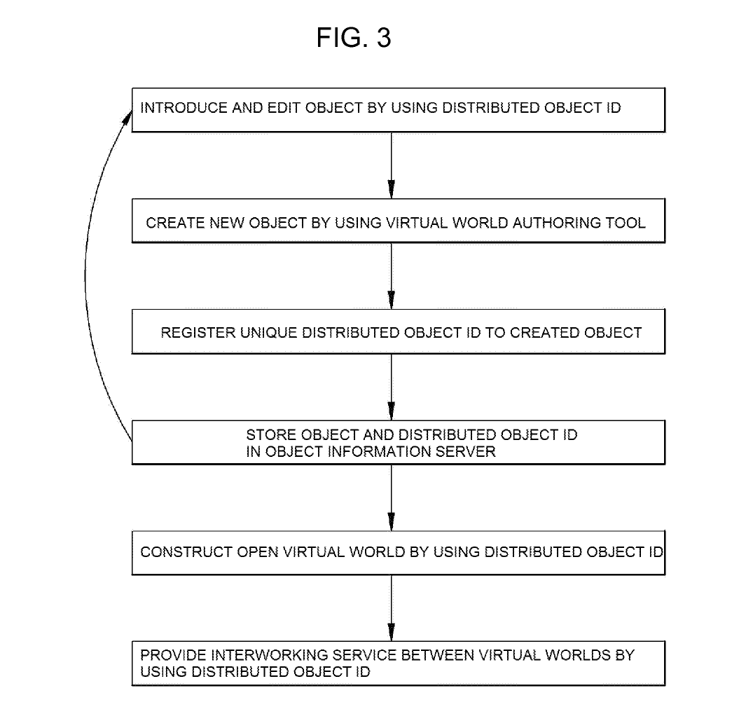

A virtual world authoring tool which is an essential part for constructing and managing a distributed object ID as shown in FIG. 3 assigns a distributed object ID to an object so that objects (e.g., an avatar, a spatial object, and multimedia) existing in different data formats in heterogeneous object information servers interwork with one another among a plurality of distributed virtual worlds.

A main function of the virtual world authoring tool is to create an object. An object which may be used in a virtual world may be created by using the virtual world authoring tool. The virtual world authoring tool may draw and create a new object in association with a 3D CAD system, may introduce and edit an existing object by using a corresponding distributed object ID, and may create a new object by combining the existing object introduced by using the distributed object ID with one or more other objects. An object may not be necessarily visual and may be abstract such as intelligence or experience.

Another main function of the virtual world authoring tool is to assign a universally unique distributed object ID to a newly crated object.

Another main function of the virtual world authoring tool is to create, edit, merge, search for, and erase a complex object formed by combining a plurality of objects having respective distributed object IDs, and to assign a distributed object ID to the complex object consisting of the plurality of objects.

Since an object created by using the virtual world authoring tool is registered and stored along with a universally unique distributed object ID in an object information database of a specific object information server, data may be efficiently shared by using the distributed object ID among a plurality of different virtual worlds.

### Embodiment 3

A case where an open virtual world includes three virtual worlds will be explained with reference to FIG. 1.

The three virtual worlds are connected through the Internet, and the following explanation will focus on a virtual world server 1 VW1 which is in the middle.

The virtual world server 1 which is an essential Web server for constructing and operating a virtual world 1 provides functions such as registration, storage, editing, erasure, and search to maintain and manage information needed to create and operate the virtual world 1. Also, there exist an avatar information server, a spatial location information server, and a content information server separate from the virtual world server 1, and information which the virtual world server 1 maintains and manages includes information needed for an interworking service with the avatar information server, the spatial location information server, and the content information server.

The avatar information server maintains and manages information related to an avatar belonging to the virtual world 1, registers, stores, and manages a distributed object ID of each avatar belonging to the virtual world 1, and includes object information such as a costume, a tool, or a currency which the avatar owns and information such as facial expression of the avatar as avatar attribute information. In this case, the object information such as a costume, a tool, or a currency is assigned a distributed object ID, registered, stored, and managed in an object information server for each content, and is included as part of the avatar attribute information by using the distributed object ID according to content. Also, when an avatar belonging to the virtual world 1 exchanges a message with another avatar, the avatar information server provides a message transmission/reception service by using a distributed object ID corresponding to the avatar. Although the avatar information server is separately operated from the virtual world server 1 in general, if necessary, a function of the avatar information server may be integrated into the virtual world server 1.

The spatial location information server maintains and manages virtual space construction information of the virtual world 1 including spatial objects such as a tree, a river, and a building which are registered and stored in a plurality of distributed content information servers. When a specific spatial object is to be introduced by using an authoring tool, the spatial location information server connects to the content information server through the Internet by using a distributed object ID of a corresponding object and introduces corresponding object information. Also, when an arbitrary spatial object is made by using an authoring tool and added to the virtual world 1 instead of being introduced from the content information server, the spatial location information server provides a service of registering, storing, and managing related information. Also, the spatial location information server provides a service of registering, storing, and managing both a distributed object ID and corresponding location information to universally and uniquely identify a specific location in a virtual space constituting the virtual world 1. Although the spatial location information server is separately operated from the virtual world server 1 in general, if necessary, a function of the spatial location information server may be integrated into the virtual world server 1.

The content information server which is a separate server classified according to various content types or suppliers includes an object constituting a virtual world such as a tree, a river, or a building, and an object which an avatar owns such as a costume, a tool, or a currency. The content information server assigns a distributed object ID for uniquely identifying content according to content objects to each content, registers, stores, and manages content in an object information server, and if necessary in an arbitrary virtual world, may easily and conveniently share content by using a distributed object ID of a corresponding object.

Referring to FIG. 1, there further exist two avatars, that is, avatar 1 # AVT2 and avatar 2 # AVT2 which belong to a virtual world 2 and move to and act in the virtual world 1, and one avatar, that is, avatar 1 # AVT3 which belongs to a virtual world 3 and moves to and acts in the virtual world 1, to four avatars, that is, avatar 1 # AVT1 through avatar 4 # AVT1 which belong to the virtual world 1. A service related to an avatar belonging to a specific virtual world is handled by an avatar information server of a virtual world to which the avatar belongs, irrespective of a virtual world to which and in which the avatar moves and acts. For example, information about an avatar belonging to the virtual world 2 is registered, stored, and managed in an avatar information server #AVT2 of the virtual world 2, and information related to an avatar belonging to the virtual world 3 is registered, stored, and managed in an avatar information server #AVT3 of the virtual world 3. Also, when an avatar belonging to an arbitrary virtual world moves to and acts in the virtual world 1, if information related to the avatar is needed in the virtual world 1 in which the avatar currently acts, the virtual world 1 may refer to the information by linking to attribute information by using a distributed object ID of the avatar.

In a similar manner, object information such as an avatar, a spatial location, or content may be shared among a plurality of different virtual worlds by using a distributed object ID.

### Embodiment 4

There is provided a method of providing an interworking service among a plurality of distributed virtual worlds by using an interworking system among the plurality of distributed virtual worlds using a universally unique ‘distributed object ID’, wherein the interworking system includes:

an object information database that includes a ‘distributed object ID’ and heterogeneous object information such as an avatar, a spatial object, multimedia content, or location information in a virtual world which is uniquely identified by using the ‘distributed object ID’, wherein the ‘distributed object ID’ includes an ‘object identifier’ and an ‘object information server domain name’ and is formatted with a ‘delimiter’ between the ‘object identifier’ and the ‘object information server domain name’, wherein the ‘object information server domain name’ is a unique character string indicating a domain name of an object information server in which object information is registered and stored and the ‘object identifier’ is a unique character string in the same object information server to uniquely identify the object information registered and stored in the object information server;

an object information server that registers, stores, updates, and erases the ‘distributed object ID’ and the object information in the object information database, searches for information stored in the object information database by using the ‘distributed object ID’ in response to a user's request, and provides a search result;

an object information server domain name server that registers, stores, and manages an IP address corresponding to the object information server, and searches for and provides the IP address in response to the user's request to connect to the object information server;

a virtual world authoring tool that has

a function of accessing at least one or more of objects registered and stored in a plurality of distributed object information servers and editing, erasing, and storing each object by using a ‘distributed object ID’, and

a function of providing a method of combining a plurality of objects having ‘distributed object IDs’ to obtain a complex object and newly creating or assigning a ‘distributed object ID’ to the complex object, or

providing a unit for newly creating an object and newly assigning a ‘distributed object ID’ to the created object, and

constructing a virtual world using a plurality of distributed object IDs such that an object information server in which a corresponding object is registered and stored is connected and corresponding object information stored in an object information database of the connected object information server is shared;

a virtual world server that is connected through the object information server, the object information server domain name server, and a wired/wireless communication network, and provides

a virtual world construction service by which a virtual world is constructed by using an object such as an avatar, a spatial object, or a multimedia content by using the ‘distributed object ID’ registered and stored in the object information database of the object information server,

a virtual world location-based service by which location information in the virtual world associated with the ‘distributed object ID’ is registered, searched for, and moved,

a search and application service of multimedia content associated with the ‘distributed object ID’, and

an interworking service among a plurality of virtual worlds using the ‘distributed object ID’ including the exchange of information between a user and an avatar or between an avatar and an avatar associated with the ‘distributed object ID’; and

a user terminal that is connected through the virtual world server, the object information server, the object information server domain name server, and the wired/wireless communication network, connects to the virtual world in response to the user's request, and provides a virtual world service associated with the ‘distributed object ID’,

wherein an interworking service among a plurality of virtual worlds is provided by associating a plurality of object information servers, a ‘distributed object ID’ for universally and uniquely identifying object information registered and stored in the plurality of object information servers, and the object information,

the method including:

introducing, editing, and creating a so-called spatial object that constitutes a two-dimensional (2D) or three-dimensional (3D) virtual space by using the virtual world authoring too, designating a ‘distributed object ID’ for universally and uniquely identifying the created spatial object, and registering and storing the ‘distributed object ID’ along with the created spatial object in an object information database of a specific object information server;

designating a ‘distributed object ID’ for universally and uniquely identifying multimedia content, and registering and storing the ‘distributed object ID along with corresponding content in an object information database of a specific object information server;

creating an arbitrary virtual world by introducing and editing multimedia content and a spatial object corresponding to the ‘distributed object ID’ in association with the ‘distributed object ID’ registered and stored in object information databases of a plurality of distributed object information servers by using the virtual world authoring tool, and registering and storing construction, management, and operation information of the created virtual world in the ‘virtual world server’;

creating an avatar by using a virtual world authoring tool upon receiving a request from a user who uses the user terminal connecting to a specific virtual world server, and

designating a ‘distributed object ID’ for universally and uniquely identifying the created avatar, and registering and storing the ‘distributed object ID’ along with the avatar in an object information database of a specific object information server;

designating a ‘distributed object ID’ for universally and uniquely identifying an arbitrary location in the virtual world upon receiving request from the user who uses the user terminal connecting to the specific virtual world server, and registering and storing the ‘distributed object ID’ along with corresponding location information in an object information database of a specific information server;

connecting to an ‘object information server domain name server’ for an object information sharing service using a ‘distributed object ID’ in the user terminal connecting to the specific virtual world server, providing an ‘object information server domain name’ constituting a ‘distributed object ID’ to the ‘object information server domain name server’ to request an IP address of a corresponding object information server, and receiving the IP address of the corresponding object information server from the ‘object information server domain name server; and

connecting to the corresponding object information server by sing the IP address of the object information server received by the user terminal, providing an ‘object identifier’constituting the ‘distributed object ID’ to the connected object information server to request to search for information related to an object corresponding to the ‘object identifier’, and providing an application service by using the object information received from the object information server.

### Embodiment 5

When an object information sharing service using the ‘distributed object ID’ in the user terminal connecting to the specific virtual world server is a service of exchanging information between an avatar and an avatar, the method of providing an interworking service among a plurality of distributed virtual worlds by using the interworking system among the plurality of distributed virtual worlds using a universally unique ‘distributed object ID’ further includes:

designating a ‘distributed object ID’ of an avatar at a receiver side as a receiver address by using software for exchanging information between an avatar and an avatar and forming exchange information by using multimedia including a character string, sound, a photograph, and a motion picture, wherein the designating is performed by the user of an avatar at a transmitter side;

connecting to an ‘object information server domain name server’, providing an ‘object information server domain name’ constituting the ‘distributed object ID’ of the avatar at the receiver side to the ‘object information server domain name server’ to request an IP address of a corresponding object information server, and receiving the IP address of the corresponding object information server from the ‘object information server domain name server’, wherein the connecting is performed by the software for exchanging information between an avatar and an avatar;

connecting to the corresponding object information server by using the received IP address of the object information server, providing an ‘object identifier’ constituting the ‘distributed object identifier’ of the avatar at the receiver side and the exchange information to the object information server to request the avatar at the receiver side corresponding to the corresponding ‘object identifier’ to transmit exchange information', wherein the connecting is performed by the software for exchanging information between an avatar and an avatar;

storing the received exchange information in an object information database corresponding to the ‘object identifier’ of the avatar at the receiver side, wherein the storing is performed by the object information server; and

connecting to an object information server by using an IP address corresponding to an ‘object information server domain name’ of the ‘distributed object ID’ of the avatar at the receiver side, providing an ‘object identifier’ constituting the ‘distributed object ID’ to the object information server to request to provide reception information through a process of checking whether the exchange information corresponding to the corresponding ‘object identifier’ is received, and receiving and using the reception information from the object information server, wherein the connecting is performed by the user of the avatar at the receiver side.

### Embodiment 6

An object of a virtual world further includes a Web-based multimedia object having a universally unique resource locator (URL) address, a an object information database registers and stores a ‘distributed object ID’ and an URL address of a corresponding object in an object information database of the same object information server, and a user terminal connects to the corresponding object information server by using the ‘distributed object ID’ and an ‘object information server domain name’, provides an ‘object identifier’ to the object information server to request to search for an URL address of a corresponding object, and is connected to and uses the corresponding object by using the URL address received from the object information server.

### Embodiment 7

An object of a virtual world further includes multimedia content having a so-called ‘universal content identifier (UCI)’, an object information database registers and stores a ‘distributed object ID’ and a ‘UCI’ of corresponding content in an object information database of the same object information server, and a user terminal connects to a corresponding object information server by using an ‘object information server domain name’ of the ‘distributed object ID’, provides an ‘object identifier’ to the object information server to request to search for a so-called ‘UCI’, and is connected to and uses the corresponding object by using the so-called ‘UCI’ received from the object information server.

### Embodiment 8

An ‘object information server domain name server’ further includes a domain name server (DNS) which is a principle domain name server of the Internet.

### Embodiment 9

There is provided a method of providing an open search service of searching for object information including a specific character string in object information databases of a plurality of distributed object information servers by using an interworking system among a plurality of distributed virtual worlds using a universally unique ‘distributed object ID’, wherein the interworking system includes:

an object information database that includes a ‘distributed object ID’ and heterogeneous object information such as an avatar, a spatial object, multimedia content, or location information in a virtual world which is uniquely identified by using the ‘distributed object ID’, wherein the ‘distributed object ID’ includes an ‘object identifier’ and an ‘object information server domain name’ and is formatted with a ‘delimiter’ between the ‘object identifier’ and the ‘object information server domain name’, wherein the ‘object information server domain name’ is a unique character string indicating a domain name of an object information server in which object information is registered and stored and the ‘object identifier’ is a unique character string in the same object information server to uniquely identify the object information registered and stored in the object information server;

an object information server that registers, stores, updates, and erases the ‘distributed object ID’ and the object information in the object information database, searches for information stored in the object information database by using the ‘distributed object ID’ in response to a user's request, and provides a search result;

an object information server domain name server that registers, stores, and manages an IP address corresponding to the object information server, and searches for and provides the IP address in response to the user's request to connect to the object information server;

a virtual world authoring tool that has

a function of accessing at least one or more of objects registered and stored in a plurality of distributed object information servers and editing, erasing, and storing each object by using a ‘distributed object ID’, and

a function of providing a method of combining a plurality of objects having ‘distributed object IDs’ to obtain a complex object and newly creating or assigning a ‘distributed object ID’ to the complex object, or

providing a unit for newly creating an object and newly assigning a ‘distributed object ID’ to the created object, and

constructing a virtual world using a plurality of distributed object IDs such that an object information server in which a corresponding object is registered and stored is connected and corresponding object information stored in an object information database of the connected object information server is shared;

a virtual world server that is connected through the object information server, the object information server domain name server, and a wired/wireless communication network, and provides

a virtual world construction service by which a virtual world is constructed by using an object such as an avatar, a spatial object, or a multimedia content by using the ‘distributed object ID’ registered and stored in the object information database of the object information server,

a virtual world location-based service by which location information in the virtual world associated with the ‘distributed object ID’ is registered, searched for, and moved,

a search and application service of multimedia content associated with the ‘distributed object ID’, and

an interworking service among a plurality of virtual worlds using the ‘distributed object ID’ including the exchange of information between a user and an avatar or between an avatar and an avatar associated with the ‘distributed object ID’; and

a user terminal that is connected through the virtual world server, the object information server, the object information server domain name server, and the wired/wireless communication network, connects to the virtual world in response to the user's request, and provides a virtual world service associated with the ‘distributed object ID’,

wherein an interworking service among a plurality of virtual worlds is provided by associating a plurality of object information servers, a ‘distributed object ID’ for universally and uniquely identifying object information registered and stored in the plurality of object information servers, and the object information,

the method including:

inputting a character string to be searched for to a search box which provides an open search service, wherein the inputting is performed by the user of the user terminal;

connecting to a so-called ‘object information server domain name server’, and requesting and receiving each IP address of at least one ‘object information server’ registered in the ‘object information server domain name server’, wherein the connecting is performed by the user terminal;

connecting to each ‘object information server’ by using received IP addresses corresponding to a plurality of received ‘object information servers’, providing the character string to the ‘object information server’, and requesting to search for a ‘distributed object ID’ or object information including the character string, wherein the connecting is performed by the user terminal;

searching for the ‘distributed object ID’ and the object information registered and stored in each object information database and providing a list of ‘distributed object IDs’ of objects including the character string to the user terminal, wherein searching is performed by the object information server receiving the request to search for the character string;

lexically ordering the list of the ‘distributed object IDs’ received as a search result from the plurality of object information servers and displaying the list on a screen, wherein the lexically ordering is performed by the user terminal; and

selecting an arbitrary ‘distributed object ID’ from among the list of the ‘distributed object IDs’ displayed on the screen of the user terminal, connecting to an object information server in which the selected ‘distributed object ID’ is registered and stored, receiving one or more object information associated with the corresponding ‘distributed object ID’, and displaying the object information on the screen, wherein the selecting is performed by the user.

### Embodiment 10

When an object related to a virtual world service further includes a Web-based multimedia object and an object information database registers and stores a ‘distributed object ID’ and an URL address of a corresponding object in an object information database of the same object information server corresponding to an ‘object information server domain name’ of the ‘distributed object ID’,

the method of providing an open search service of searching for object information including a specific character string in object information databases of a plurality of distributed object information servers by using the interworking system among a plurality of distributed virtual worlds using a universally unique ‘distributed object ID’ further includes:

receiving each IP address corresponding to at least one ‘object information server’ from the ‘object information server domain name server’ and connecting to each object information server by using the received IP address, wherein the receiving is performed by the user terminal;

providing a character string to the object information server to request to search for the ‘distributed object ID’ including the corresponding character string, wherein the providing is performed by the user terminal;

searching for the ‘distributed object ID’ registered and stored in each object information database and providing a list of ‘distributed object IDs’ including the received character string to the user terminal, wherein the searching is performed by the object information server requested to search for the character string;

lexically ordering the list of the ‘distributed object IDs’ received as a search result from the plurality of object information servers and displaying the list on a screen, wherein the lexically ordering is performed by the user terminal;

selecting an arbitrary ‘distributed object ID’ from among the list of the ‘distributed object IDs’ displayed on the screen of the user terminal, connecting to an object information server in which the selected ‘distributed object ID’ is registered and stored, and receiving one or more object information associated with the corresponding ‘distributed object ID’, wherein the selecting is performed by the user terminal; and

connecting to and using the corresponding object by using the URL address received from the object information server.

### Embodiment 11

When an object related to a virtual world service further includes a multimedia object having a UCI and an object information database registers and stores a ‘distributed object ID’ and a UCI of a corresponding object in an object information database of the same object information server corresponding to an ‘object information server domain name’ of the ‘distributed object ID’,

the method of providing an open search service of searching for object information including a specific character string in object information databases of a plurality of distributed object information servers by using the interworking system among a plurality of distributed virtual worlds using a universally unique ‘distributed object ID’ further includes:

receiving each IP address corresponding to at least one ‘object information server’ from the ‘object information server domain name server’ and connecting to each object information server by using the received IP address, wherein the receiving is performed by the user terminal;

providing a character string to be searched to the object information server to request to search for the ‘distributed object ID’ including the corresponding character string and object information, wherein the providing is performed by the user terminal;

searching for the ‘distributed object ID’ registered and stored in each object information database and providing a list of ‘distributed object IDs’ including the received character string to the user terminal, wherein the searching is performed by the object information server requested to search for the character string;

lexically ordering the list of the ‘distributed object IDs’ received as a search result from the plurality of object information servers and displaying the list on a screen, wherein the lexically ordering is performed by the user terminal;

selecting an arbitrary ‘distributed object ID’ from among the list of the ‘distributed object IDs’ displayed on the screen of the user terminal, connecting to an object information server in which the selected ‘distributed object ID’ is registered and stored, and receiving a UCI associated with the corresponding ‘distributed object ID’, wherein the selecting is performed by the user; and

connecting to and using the corresponding object by using the universal content ID received from the object information server.

### Embodiment 12

An ‘object information server domain name server’ further includes a DNS which is a principle domain name server of the Internet.

According to the present invention, since a virtual world object includes an object having a URL address, an object having a UCI, and an object managed via a DB without a URL address or a UCI and the use of a distributed object ID for uniquely and universally identifying various objects with the same format enables interworking and sharing among a number of virtual worlds, an open virtual world may be implemented more easily and efficiently.

That is, unlike a traditional closed virtual world, an open virtual world is characterized in that an application service through interworking is provided so that various pieces of object information may be shared among a plurality of different kinds of distributed virtual worlds, an avatar belonging to a specific virtual world may freely move from one virtual world to another virtual world, and information may be exchanged between avatars belonging to different virtual worlds.

According to an interworking system among a plurality of distributed virtual worlds and a method for the same of the present invention, since any of all objects existing in a virtual world including avatars existing in a plurality of virtual worlds, spatial objects constituting 2D or 3D virtual spaces, location information of avatars and spatial objects in virtual spaces, and multimedia content is registered by using a universally unique ‘distributed object ID’ in an ‘object identifier # object information server identifier’ format and stored along with object information in an object information server, and ‘distributed object IDs’ registered and stored in object information servers in a plurality of different kinds of distributed virtual worlds are used, all the objects existing in the virtual world such as the avatars, the spatial objects, the location information, and the multimedia content may interwork with one another among a plurality of different kinds of distributed virtual worlds. When the present invention is applied to a plurality of different kinds of virtual worlds, an open virtual world allowing interworking may be implemented more easily and efficiently.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An interworking system among a plurality of different kinds of distributed virtual worlds by using a unique distributed object ID, the interworking system comprising a virtual world authoring tool that has
a function of accessing at least one or more of objects registered and stored in a plurality of distributed object information servers and editing, erasing, and storing each object by using a ‘distributed object ID’, and
a function of providing a method of combining a plurality of objects having ‘distributed object IDs’ to obtain a complex object and newly creating or assigning a ‘distributed object ID’ to the complex object, or
providing a unit for newly creating an object and newly assigning a ‘distributed object ID’ to the created object, and
constructing a virtual world using a plurality of distributed object IDs such that an object information server in which a corresponding object is registered and stored is connected and corresponding object information stored in an object information database of the connected object information server is shared.

2. The interworking system of claim 1, wherein the ‘distributed object ID’ is created in an ‘object ID “delimiter” object information server domain name’ format comprising a delimiter.

3. The interworking system of claim 2, wherein the ‘delimiter’ is any one of #, !, $, %, ̂, and &.

4. The interworking system of claim 1, wherein the object information database comprises a ‘distributed object ID’ for uniquely identifying heterogeneous object information such as an avatar, a spatial location, and multimedia content, and corresponding object information.

5. The interworking system of claim 1, wherein the object information server registers, stores, updates, and erases a ‘distributed object ID’ and object information in the object information database, and searches for information stored in the object information database by using the ‘distributed object ID’ in response to a user's request and provides a search result.

6. The interworking system of claim 1, further comprising an object information server domain name server that registers, stores, and manages an Internet protocol (IP) address corresponding to the object information server and an ‘object information server domain name’ constituting a ‘distributed object ID’, and searches for and provides an IP address corresponding to the ‘object information server domain name’ in response to the user's request to connect to the object information server.

7. The interworking system of claim 6, further comprising a virtual world server that is connected through the object information server, the object information server domain name server, and a wired/wireless communication network, and provides
a virtual world construction service by which a virtual world is constructed by using an object such as an avatar, a spatial object, or a multimedia content by using the ‘distributed object ID’ registered and stored in the object information database of the object information server,
a virtual world location-based service by which location information in the virtual world associated with the ‘distributed object ID’ is registered, searched for, and moved,
a search and application service of multimedia content associated with the ‘distributed object ID’, and
an interworking service among a plurality of virtual worlds using the ‘distributed object ID’ comprising the exchange of information between a user and an avatar or between an avatar and an avatar associated with the ‘distributed object ID’.

8. The interworking system of claim 7, further comprising a user terminal that is connected through the virtual world server, the object information server, the object information server domain name server, and the wired/wireless communication network, connects to the virtual world according to the user's request, and provides a virtual world service associated with the ‘distributed object ID’.

9. A method of providing an interworking service among a plurality of distributed virtual worlds by using an interworking system among the plurality of distributed virtual worlds using a universally unique ‘distributed object ID’, wherein the interworking system comprises:
an object information database that comprises a ‘distributed object ID’ and heterogeneous object information such as an avatar, a spatial object, multimedia content, or location information in a virtual world which is uniquely identified by using the ‘distributed object ID’, wherein the ‘distributed object ID’ comprises an ‘object identifier’ and an ‘object information server domain name’ and is formatted with a ‘delimiter’ between the ‘object identifier’ and the ‘object information server domain name’, wherein the ‘object information server domain name’ is a unique character string indicating a domain name of an object information server in which object information is registered and stored and the ‘object identifier’ is a unique character string in the same object information server to uniquely identify the object information registered and stored in the object information server;
an object information server that registers, stores, updates, and erases the ‘distributed object ID’ and the object information in the object information database, searches for information stored in the object information database by using the ‘distributed object ID’ in response to a user's request, and provides a search result;
an object information server domain name server that registers, stores, and manages an IP address corresponding to the object information server, and searches for and provides the IP address in response to the user's request to connect to the object information server;
a virtual world authoring tool that has
a function of accessing at least one or more of objects registered and stored in a plurality of distributed object information servers and editing, erasing, and storing each object by using a ‘distributed object ID’, and
a function of providing a method of combining a plurality of objects having ‘distributed object IDs’ to obtain a complex object and newly creating or assigning a ‘distributed object ID’ to the complex object, or
providing a unit for newly creating an object and newly assigning a ‘distributed object ID’ to the created object, and
constructing a virtual world using a plurality of distributed object IDs such that an object information server in which a corresponding object is registered and stored is connected and corresponding object information stored in an object information database of the connected object information server is shared;
a virtual world server that is connected through the object information server, the object information server domain name server, and a wired/wireless communication network, and provides
a virtual world construction service by which a virtual world is constructed by using an object such as an avatar, a spatial object, or a multimedia content by using the ‘distributed object ID’ registered and stored in the object information database of the object information server,
a virtual world location-based service by which location information in the virtual world associated with the ‘distributed object ID’ is registered, searched for, and moved,
a search and application service of multimedia content associated with the ‘distributed object ID’, and
an interworking service among a plurality of virtual worlds using the ‘distributed object ID’ comprising the exchange of information between a user and an avatar or between an avatar and an avatar associated with the ‘distributed object ID’; and
a user terminal that is connected through the virtual world server, the object information server, the object information server domain name server, and the wired/wireless communication network, connects to the virtual world in response to the user's request, and provides a virtual world service associated with the ‘distributed object ID’,
wherein an interworking service among a plurality of virtual worlds is provided by associating a plurality of object information servers, a ‘distributed object ID’ for universally and uniquely identifying object information registered and stored in the plurality of object information servers, and the object information,
the method comprising:
introducing, editing, and creating a so-called spatial object that constitutes a two-dimensional (2D) or three-dimensional (3D) virtual space by using the virtual world authoring too, designating a ‘distributed object ID’ for universally and uniquely identifying the created spatial object, and registering and storing the ‘distributed object ID’ along with the created spatial object in an object information database of a specific object information server;
designating a ‘distributed object ID’ for universally and uniquely identifying multimedia content, and registering and storing the ‘distributed object ID along with corresponding content in an object information database of a specific object information server;
creating an arbitrary virtual world by introducing and editing multimedia content and a spatial object corresponding to the ‘distributed object ID’ in association with the ‘distributed object ID’ registered and stored in object information databases of a plurality of distributed object information servers by using the virtual world authoring tool, and registering and storing construction, management, and operation information of the created virtual world in the ‘virtual world server’;
creating an avatar by using a virtual world authoring tool upon receiving a request from a user who uses the user terminal connecting to a specific virtual world server, and designating a ‘distributed object ID’ for universally and uniquely identifying the created avatar, and registering and storing the ‘distributed object ID’ along with the avatar in an object information database of a specific object information server;
designating a ‘distributed object ID’ for universally and uniquely identifying an arbitrary location in the virtual world upon receiving request from the user who uses the user terminal connecting to the specific virtual world server, and registering and storing the ‘distributed object ID’ along with corresponding location information in an object information database of a specific information server;
connecting to an ‘object information server domain name server’ for an object information sharing service using a ‘distributed object ID’ in the user terminal connecting to the specific virtual world server, providing an ‘object information server domain name’ constituting a ‘distributed object ID’ to the ‘object information server domain name server’ to request an IP address of a corresponding object information server, and receiving the IP address of the corresponding object information server from the ‘object information server domain name server; and
connecting to the corresponding object information server by sing the IP address of the object information server received by the user terminal, providing an ‘object identifier’ constituting the ‘distributed object ID’ to the connected object information server to request to search for information related to an object corresponding to the ‘object identifier’, and providing an application service by using the object information received from the object information server.

10. The method of claim 9, wherein the ‘distributed object ID’ further comprises an ‘object identifier # object information server domain name’ using # as a delimiter,
wherein the delimiter further comprises #, !, $, %, ̂, & and *.

11. The method of claim 9, wherein when an object information sharing service using the ‘distributed object ID’ in the user terminal connecting to the specific virtual world server is a service of exchanging information between an avatar and an avatar, the method further comprises:
designating a ‘distributed object ID’ of an avatar at a receiver side as a receiver address by using software for exchanging information between an avatar and an avatar and forming exchange information by using multimedia comprising a character string, sound, a photograph, and a motion picture, wherein the designating is performed by the user of an avatar at a transmitter side;
connecting to an ‘object information server domain name server’, providing an ‘object information server domain name’ constituting the ‘distributed object ID’ of the avatar at the receiver side to the ‘object information server domain name server’ to request an IP address of a corresponding object information server, and receiving the IP address of the corresponding object information server from the ‘object information server domain name server’, wherein the connecting is performed by the software for exchanging information between an avatar and an avatar;
connecting to the corresponding object information server by using the received IP address of the object information server, providing an ‘object identifier’ constituting the ‘distributed object identifier’ of the avatar at the receiver side and the exchange information to the object information server to request the avatar at the receiver side corresponding to the corresponding ‘object identifier’ to transmit exchange information', wherein the connecting is performed by the software for exchanging information between an avatar and an avatar;
storing the received exchange information in an object information database corresponding to the ‘object identifier’ of the avatar at the receiver side, wherein the storing is performed by the object information server; and
connecting to an object information server by using an IP address corresponding to an ‘object information server domain name’ of the ‘distributed object ID’ of the avatar at the receiver side, providing an ‘object identifier’ constituting the ‘distributed object ID’ to the object information server to request to provide reception information through a process of checking whether the exchange information corresponding to the corresponding ‘object identifier’ is received, and receiving and using the reception information from the object information server, wherein the connecting is performed by the user of the avatar at the receiver side.

12. The method of claim 9, wherein an object of a virtual world further comprises a Web-based multimedia object having a universally unique resource locator (URL) address, a an object information database registers and stores a ‘distributed object ID’ and an URL address of a corresponding object in an object information database of the same object information server, and a user terminal connects to the corresponding object information server by using the ‘distributed object ID’ and an ‘object information server domain name’, provides an ‘object identifier’ to the object information server to request to search for an URL address of a corresponding object, and is connected to and uses the corresponding object by using the URL address received from the object information server.

13. The method of claim 9, wherein an object of a virtual world further comprises multimedia content having a so-called ‘universal content identifier (UCI)’, an object information database registers and stores a ‘distributed object ID’ and a ‘UCI’ of corresponding content in an object information database of the same object information server, and a user terminal connects to a corresponding object information server by using an ‘object information server domain name’ of the ‘distributed object ID’, provides an ‘object identifier’ to the object information server to request to search for a so-called ‘UCI’, and is connected to and uses the corresponding object by using the so-called ‘UCI’ received from the object information server.

14. The method of claim 9, wherein an ‘object information server domain name server’ further comprises a domain name server (DNS) which is a principle domain name server of the Internet.

15. A method of providing an open search service of searching for object information comprising a specific character string in object information databases of a plurality of distributed object information servers by using an interworking system among a plurality of distributed virtual worlds using a universally unique ‘distributed object ID’, wherein the interworking system comprises:
an object information database that comprises a ‘distributed object ID’ and heterogeneous object information such as an avatar, a spatial object, multimedia content, or location information in a virtual world which is uniquely identified by using the ‘distributed object ID’, wherein the ‘distributed object ID’ comprises an ‘object identifier’ and an ‘object information server domain name’ and is formatted with a ‘delimiter’ between the ‘object identifier’ and the ‘object information server domain name’, wherein the ‘object information server domain name’ is a unique character string indicating a domain name of an object information server in which object information is registered and stored and the ‘object identifier’ is a unique character string in the same object information server to uniquely identify the object information registered and stored in the object information server;
an object information server that registers, stores, updates, and erases the ‘distributed object ID’ and the object information in the object information database, searches for information stored in the object information database by using the ‘distributed object ID’ in response to a user's request, and provides a search result;
an object information server domain name server that registers, stores, and manages an IP address corresponding to the object information server, and searches for and provides the IP address in response to the user's request to connect to the object information server;
a virtual world authoring tool that has
a function of accessing at least one or more of objects registered and stored in a plurality of distributed object information servers and editing, erasing, and storing each object by using a ‘distributed object ID’, and
a function of providing a method of combining a plurality of objects having ‘distributed object IDs’ to obtain a complex object and newly creating or assigning a ‘distributed object ID’ to the complex object, or
providing a unit for newly creating an object and newly assigning a ‘distributed object ID’ to the created object, and
constructing a virtual world using a plurality of distributed object IDs such that an object information server in which a corresponding object is registered and stored is connected and corresponding object information stored in an object information database of the connected object information server is shared;
a virtual world server that is connected through the object information server, the object information server domain name server, and a wired/wireless communication network, and provides
a virtual world construction service by which a virtual world is constructed by using an object such as an avatar, a spatial object, or a multimedia content by using the ‘distributed object ID’ registered and stored in the object information database of the object information server,
a virtual world location-based service by which location information in the virtual world associated with the ‘distributed object ID’ is registered, searched for, and moved, a search and application service of multimedia content associated with the ‘distributed object ID’, and
an interworking service among a plurality of virtual worlds using the ‘distributed object ID’ comprising the exchange of information between a user and an avatar or between an avatar and an avatar associated with the ‘distributed object ID’; and
a user terminal that is connected through the virtual world server, the object information server, the object information server domain name server, and the wired/wireless communication network, connects to the virtual world in response to the user's request, and provides a virtual world service associated with the ‘distributed object ID’,
wherein an interworking service among a plurality of virtual worlds is provided by associating a plurality of object information servers, a ‘distributed object ID’ for universally and uniquely identifying object information registered and stored in the plurality of object information servers, and the object information,
the method comprising:
inputting a character string to be searched for to a search box which provides an open search service, wherein the inputting is performed by the user of the user terminal;
connecting to a so-called ‘object information server domain name server’, and requesting and receiving each IP address of at least one ‘object information server’ registered in the ‘object information server domain name server’, wherein the connecting is performed by the user terminal;
connecting to each ‘object information server’ by using received IP addresses corresponding to a plurality of received ‘object information servers’, providing the character string to the ‘object information server’, and requesting to search for a ‘distributed object ID’ or object information comprising the character string, wherein the connecting is performed by the user terminal;
searching for the ‘distributed object ID’ and the object information registered and stored in each object information database and providing a list of ‘distributed object IDs’ of objects comprising the character string to the user terminal, wherein searching is performed by the object information server receiving the request to search for the character string;
lexically ordering the list of the ‘distributed object IDs’ received as a search result from the plurality of object information servers and displaying the list on a screen, wherein the lexically ordering is performed by the user terminal; and
selecting an arbitrary ‘distributed object ID’ from among the list of the ‘distributed object IDs’ displayed on the screen of the user terminal, connecting to an object information server in which the selected ‘distributed object ID’ is registered and stored, receiving one or more object information associated with the corresponding ‘distributed object ID’, and displaying the object information on the screen, wherein the selecting is performed by the user.

16. The method of claim 15, wherein a ‘distributed object ID’ further comprises an ‘object identifier # object information server domain name’ which is a character string comprising # as a ‘delimiter’, the ‘delimiter’ further comprises #, !, $, %, ̂, &, and *.

17. The method of claim 15, wherein when an object related to a virtual world service further comprises a Web-based multimedia object and an object information database registers and stores a ‘distributed object ID’ and an URL address of a corresponding object in an object information database of the same object information server corresponding to an ‘object information server domain name’ of the ‘distributed object ID’,
the method further comprises:
receiving each IP address corresponding to at least one ‘object information server’ from the ‘object information server domain name server’ and connecting to each object information server by using the received IP address, wherein the receiving is performed by the user terminal;
providing a character string to the object information server to request to search for the ‘distributed object ID’ comprising the corresponding character string, wherein the providing is performed by the user terminal;
searching for the ‘distributed object ID’ registered and stored in each object information database and providing a list of ‘distributed object IDs’ comprising the received character string to the user terminal, wherein the searching is performed by the object information server requested to search for the character string;
lexically ordering the list of the ‘distributed object IDs’ received as a search result from the plurality of object information servers and displaying the list on a screen, wherein the lexically ordering is performed by the user terminal;
selecting an arbitrary ‘distributed object ID’ from among the list of the ‘distributed object IDs’ displayed on the screen of the user terminal, connecting to an object information server in which the selected ‘distributed object ID’ is registered and stored, and receiving one or more object information associated with the corresponding ‘distributed object ID’, wherein the selecting is performed by the user terminal; and
connecting to and using the corresponding object by using the URL address received from the object information server.

18. The method of claim 15, wherein when an object related to a virtual world service further comprises a multimedia object having a UCI and an object information database registers and stores a ‘distributed object ID’ and a UCI of a corresponding object in an object information database of the same object information server corresponding to an ‘object information server domain name’ of the ‘distributed object ID’,
the method further comprises:
receiving each IP address corresponding to at least one ‘object information server’ from the ‘object information server domain name server’ and connecting to each object information server by using the received IP address, wherein the receiving is performed by the user terminal;
providing a character string to be searched to the object information server to request to search for the ‘distributed object ID’ comprising the corresponding character string and object information, wherein the providing is performed by the user terminal;
searching for the ‘distributed object ID’ registered and stored in each object information database and providing a list of ‘distributed object IDs’ comprising the received character string to the user terminal, wherein the searching is performed by the object information server requested to search for the character string;
lexically ordering the list of the ‘distributed object IDs’ received as a search result from the plurality of object information servers and displaying the list on a screen, wherein the lexically ordering is performed by the user terminal;
selecting an arbitrary ‘distributed object ID’ from among the list of the ‘distributed object IDs’ displayed on the screen of the user terminal, connecting to an object information server in which the selected ‘distributed object ID’ is registered and stored, and receiving a UCI associated with the corresponding ‘distributed object ID’, wherein the selecting is performed by the user; and
connecting to and using the corresponding object by using the universal content ID received from the object information server.

19. The method of claim 15, wherein an ‘object information server domain name server’ further comprises a DNS which is a principle domain name server of the Internet.
